(19) United States
(12) Patent Application Publication
(10) Pub. No.: US 2024/0356955 A1
(43) Pub. Date: Oct. 24, 2024

(54) TIME-BASED VISUALIZATION OF COMPUTER NETWORK ASSETS AND EVENTS

(71) Applicant: Cyberspatial Inc., Claymont, DE (US)

(72) Inventors: Xiao Tan, Fairbanks, AK (US); Aubrey Falconer, Careywood, ID (US)

(21) Appl. No.: 18/302,694

(22) Filed: Apr. 18, 2023

(51) Int. Cl. H04L 9/40; H04L 67/10

(52) U.S. Cl. CPC H04L 63/1433; H04L 67/10

(57) ABSTRACT

A security server for a networked computer environment monitors network assets and events and generates a user interface that provides a time-based visualization of the network state. The user interface may include at least a multi-dimensional timeline panel and a computer network visualization panel that synchronously update based on changing network state, detected events, and user interactions. The multi-dimensional timeline panel independently depicts multiple categories of events according to timing of their occurrences. The computer network visualization panel depicts the network state at a selected timepoint as a network graph showing detected network assets and connections between them.

### BACKGROUND

### Technical Field

This application relates generally to computer network security, and, in particular, to a system for time-based visualization of computer network assets and events.

### Description of Related Art

Network security, operations, intelligence, and other related tasks depends on an understanding of highly complex network environments. Such networks may contain significant numbers of physical and/or virtual computer assets of varying types and functions, may have complex and dynamically changing topologies defining connections between assets, and may operate with high rates of events of varying types. In view of these complexities, there is a significant challenge in discovery, monitoring, management, analysis, and visualization of networked environments and associated security assessments.

### BRIEF DESCRIPTION OF THE DRAWINGS

FIG. 1 is a block diagram of a networked computing environment according to one embodiment.

FIG. 2 is a block diagram of a security server according to one embodiment.

FIG. 3 is an example user interface for presenting a time-based visualization of network assets and events.

FIG. 4A is a first example layout of a user interface for presenting a time-based visualization of network assets and events.

FIG. 4B is a second example layout of a user interface for presenting a time-based visualization of network assets and events.

FIG. 4C is a third example layout of a user interface for presenting a time-based visualization of network assets and events.

FIG. 5 is an example of a synchronization feature of a user interface for presenting time-based visualization of network assets and events.

FIG. 6 is an example of a time-based comparison feature of a user interface for presenting time-based visualization of network assets and events.

FIG. 7 is an example of a selection feature of a user interface for presenting time-based visualization of network assets and events.

FIG. 8 illustrates an example embodiment of a process for generating and operating a user interface that produces time-based visualizations of network assets, events, and their attributes.

### DETAILED DESCRIPTION

The figures and the following description describe certain embodiments by way of illustration only. One skilled in the art will readily recognize from the following description that alternative embodiments of the structures and methods may be employed without departing from the principles described. Wherever practicable, similar or like reference numbers are used in the figures to indicate similar or like functionality. Where elements share a common numeral followed by a different letter, this indicates the elements are similar or identical. A reference to the numeral alone generally refers to any one or any combination of such elements, unless the context indicates otherwise.

A security server for a networked computer environment monitors network assets and events and generates a user interface that provides a time-based visualization of the network state. The user interface may include at least a multi-dimensional timeline panel and a computer network visualization panel that synchronously update based on changing network state, detected events, and user interactions. The multi-dimensional timeline panel independently depicts multiple categories of events according to timing of their occurrences. The computer network visualization panel depicts the network state at a selected timepoint as a visualization showing detected network assets and connections between them.

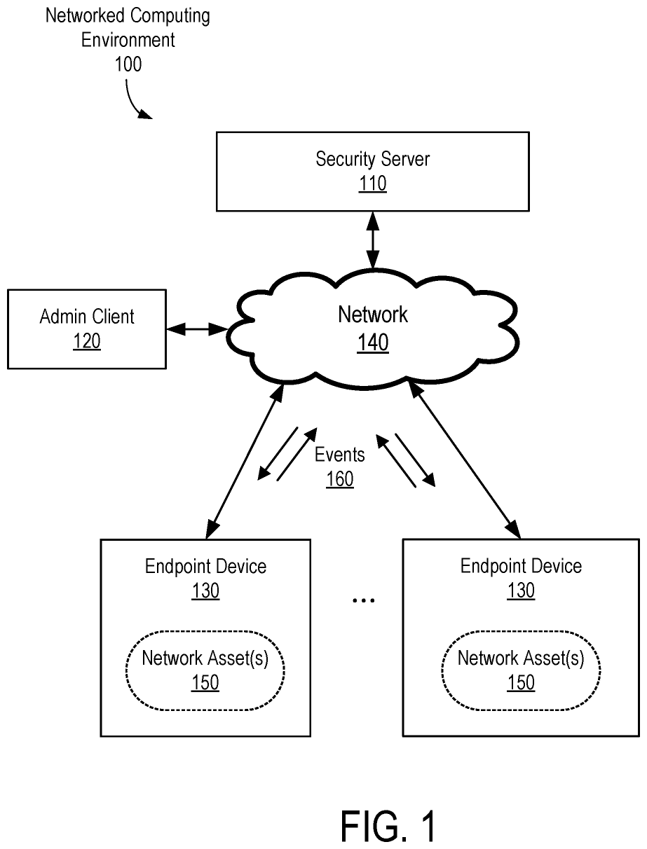

FIG. 1 illustrates one embodiment of a networked computing environment 100. The networked computing environment 100 includes a security server 110, an administrative client 120, and a set of endpoint devices 130 coupled by one or more networks 140.

The endpoint devices 130 may comprise network-enabled electronic devices coupled to the network 140. The endpoint devices 130 may include, for example, desktop computers, laptop computers, mobile devices, tablets, game consoles, Internet of Things (IoT) devices, servers, storage devices, or network infrastructure devices such as firewalls, routers, switches, or access points. The endpoint devices 130 support various network assets 150 associated with an enterprise, such as a business or other organization. The network assets 150 may include the endpoint devices 130 themselves and/or various virtual elements capable of being monitored by the security server 110. Examples of network assets 150 may include, for example, network-enabled devices, virtual machines, containers, serverless functions, Software-as-a-Service (SaaS) applications, software processes, network interfaces, domain names, configuration files, users, or groups. Some types of network assets 150, such as virtual machines and containers, may to some extent mimic operation of physical devices and may enable operations similar to physical endpoint devices 130. Other network assets 150, such as software processes and configuration files, may represent a specific set of data or executable instructions stored to an endpoint device 130. In distributed computing architectures, data or instructions associated with a single network asset 150 may be distributed between multiple physical endpoint devices 130. The set of network assets 150 on the network 140 may dynamically change over time. For example, different physical devices may be connected or disconnected from the network 140, virtual machines and/or containers may be instantiated or shut down, and various other elements may be created or deleted from storage.

One or more network assets 150 may be associated with events 160 comprising discrete operations or sequences of operations associated with the network assets 150. Events 160 may represent various information such as, for example, network flow information, network packet information, authentication information, user information, system information, application information, cloud information, security information, physical activities information, social activities information, computer-generated report and incidents, security alerts, or digital documentation and stories. The various information may be obtained from different data sources in the form of event logs associated with the different types of information or as real-time event streams. Examples of physical activities may include events associated with industrial control systems, machinery, medical devices, or equipment, events registered by security cameras, badge readers, or other sensors, or various physical events impacting data and systems of the computer network such fire, damage, loss of connectivity, loss of power, purchase, repairs, replacement, facility construction, etc. Social activities in this context may include, for example, activities taken by users of the computer network (e.g., bringing a device home), actions pertaining to users of the computer network (e.g., employee hired or fired, granted access or revoked access), actions involving users of the computer network (e.g., team meetings, vacations, calendar events).

Events 160 may be defined by one or more data dimensions that each represent a different attribute associated with the event 160. Data dimensions may include, for example, a time and history of the event 160, relationships and connections with other events 160, subject and participants, location and place, human knowledge, social, logical, physical, and digital information, or parameters such as frequency, proximity, repetition, position, size, intensity, etc. Events 160 may furthermore be indicative of changes to the network assets 150 (e.g., assets 150 coming online or going offline, connections being established or relinquished, etc.) Events 160 may occur internally to a network assets 150 and do not necessarily involve information exchange between assets 150.

The security server 110 facilitates visualization of the network assets 150 and events 160 on a network 140 for network analysis, monitoring, planning, management, forensics, or other related operations associated with applications such as network security, network operations, and network intelligence. For example, the security server 110 may identify and track which network assets 150 are present on the network 140, may detect attributes of the various network assets 150, and may monitor data events 160 associated with operations of the network assets 150. The security server 110 may perform various aggregation, filtering, or other processing of monitored data and generate an administrative user interface for viewing and interacting with various security-related information. As will be described in further detail herein, the administrative user interface may employ generate various visualizations of the network assets 150 and events 160 according to a time-based approach. In this time-based approach, a network administrator can view events 160 and changes to network assets 150 according to their relative timing using an intuitive visual interface that enables various customized views. The presentation allows for efficient recognition of event patterns that may be indicative of anomalous or malicious activities, which in turn enable rapid remediation of vulnerabilities. The time-based visualizations may illustrate the changing network state in real-time as it occurs and may enable playback of historical recorded event sequences. User interface examples are described in further detail below.

The security server 110 may execute remotely from the network 140 associated with the endpoint devices 130. For example, the endpoint devices 130 may be coupled via one or more local area networks (LANs) and the security server 110 may operate outside of the one or more LANs (e.g., in a cloud computing environment). For example, an enterprise associated with a network 140 and set of endpoint devices 130 associated with network assets 150 may collect information relating to the network assets 150 and events 160 on an enterprise network (manually or via automated sensors), and upload the information to a remote security server 110 that does not have direct access to the enterprise network. In other embodiments (e.g., in government environments or other environments handling sensitive data), the security server 110 may execute on the same network 140 as the endpoint devices 130 such that data relating to the network assets 150 and events 160 does not pass through the Internet or other network infrastructure outside the control of the enterprise.

The administrative client 120 comprises a computing device that may be operated by an administrator managing the security server 110. The administrative client 120 may enable access to the user interface described herein (e.g., via an installed application or via a web browser) for viewing information about network assets 150 and data events, configuring security settings, or performing other administrative tasks. The administrative client 120 may enable an administrator to execute various remedial actions associated with patterns of events indicative of malicious activity.

The one or more networks 140 provides communication pathways between the security server 110, the administrative client 120, and the endpoint devices 130. The network 140 may include one or more local area networks (LANs) and/or one or more wide area networks (WANs) including the Internet. Connections via the network may involve one or more wireless connections such as satellite, WiFi, Bluetooth, or cellular connections. The network 140 may furthermore be implemented using various network devices that facilitate such connections such as routers, switches, modems, firewalls, or other network architecture.

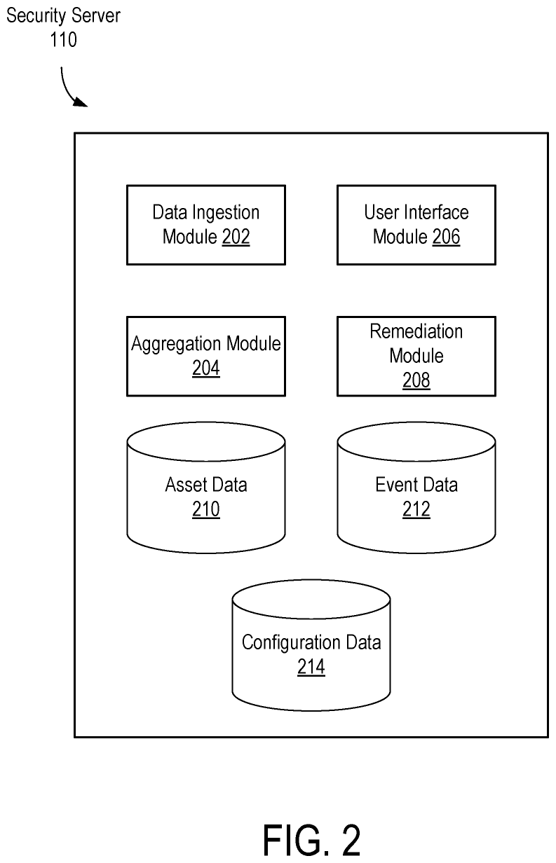

FIG. 2 is a block diagram illustrating an example embodiment of a security server 110. The security server 110 includes a data ingestion module 202, an aggregation module 204, a user interface module 206, a remediation module 208, an asset store 210, an event store 212, and a configuration store 214. In alternative embodiments, the security server 110 may include different or additional modules.

The data ingestion module 202 facilitates ingestion of data indicative of network assets 150 and occurrences of data events 160 in the networked computing environment 100. One or more different techniques may be employed to facilitate data ingestion. In one embodiment, the data ingestion module 202 obtains an application programming interface (API) key that enables access to information about assets 150 and events 160 either directly from the assets 150 or via a third-party service. Examples of data that can be collected in this manner (e.g., from a cloud service provider) include, for example, information about users, groups, and permissions, information about services, endpoints, network devices, containers, virtual machines, serverless functions, and cloud objects, or various information flow logs. Other information may be obtained via API connections to one or more information technology and/or security products that manage network assets 150 and monitor events 160 such as logs, alerts, events, configuration and settings, and/or asset information.

In another embodiment, asset and event data may be obtained from one or more agents that execute locally on the endpoint devices 130. An agent may comprise a lightweight utility application that may run native operating system level commands, organize the data into a structured format, and send the data to the data ingestion module 202 on a one-time or recurrent basis. Examples of data that can be collected using this technique include, for example, configuration files, device and system information, networking information (connections, listening ports, settings), device logs, information about user, groups settings, and permissions, and information about installed application, running processes, and resource usage (e.g., CPU usage, memory usage, disk usage, etc.)

In an embodiment, the data ingestion module 202 may employ a sensor collection technique in which a sensor connected to a network tap or port mirror reads raw network traffic as it passes through a router, firewall, switch or other networking device of the network 140 and writes a copy of the traffic as a capture file uploaded to the data ingestion module 202. Examples of data that can be captured using this technique may include network traffic, network logs, and network flow data.

In yet another embodiment, the data ingestion module 202 may employ a manual collection technique in which a user facilitates gathering of logs, configuration files, and device artifacts from existing data storage locations (e.g., a backup file server or logging server) and manually initiates a process to upload the data to an upload portal of the data ingestion module 202. Examples of data that may be collected using his technique include, for example, any of the machine-generated data listed above or human-generated data such as security policies, documentation, architecture diagrams, and spreadsheets.

In an embodiment, the data ingestion module 202 may employ a combination of any of the above techniques and/or other data ingestion techniques.

The aggregation module 204 obtains event and asset data from the data ingestion module 202 and processes the data to generate structured metadata. For example, the aggregation module 204 may normalize the ingested data from varying disparate formats depending on the data source to a standardized format. The aggregation module 204 may furthermore perform various filtering and aggregation operations. The processed event data may be stored to the event store 212 and processed asset information may be stored to the asset store 210.

The user interface module 206 generates various time-based visualizations relating to the asset and event data. Examples of such visualizations are discussed in further detail below. The user interface module 206 may further obtain and process user interactions from the administrative client 120 and update the user interface in response to the interactions. For example, the user interface module 206 may execute various analytics, queries, and filters to generate the various visualizations as further described below. The user interface module 206 may furthermore enable detection of patterns indicative of anomalous or malicious activity and may generate alerts responsive to such detection. The user interface module 206 may furthermore enable the administrator to initiate a remedial action in response to detection.

The user interface module 206 may furthermore enable users to create additional events from existing events in the timeline as reports and stories. For example, users can select a set of events indicative of a pattern of interest (e.g., indicative of anomalous or malicious activity) and use the user interface to create a time-stamped stories and/or report associated with the pattern as an additional user-created event 160. The user interface module 206 may furthermore enable users to generate and export screenshots, summary reports, and detailed asset or event data for collaborative analysis in 3^{rd} party software. Data may be exportable in various format such as images, slides, spreadsheets, or various document formats.

The remediation module 208 includes various remediation tools for remediating detected malicious activity. For example, the remediation module 308 may include various access blocking tools, network configuration tools, data recovery tools, malware removal tools, disk image restoration tools, etc. that may be applied to enable recovery from anomalous or malicious activity. Remediation may involve, for example, containment from the network, blocking code or script execution, blocking access to an IP address, port, or domain, removing a malicious application or service, revoking user permissions, recovering lost data, gathering additional security artifacts for investigation, shutting down or restarting the system, applying patch updates or new configurations, installing additional software, executing cleanup scripts, changing system settings, etc.

In an embodiment, the remediation module 208 may include an interface for integrating with one or more external security applications (which may be operated by third-parties) to perform various remediation tasks. Here, a remediation request may be manually triggered via a control interface of the user interface or may be automatically triggered based on a triggering rule. The triggering rule may be defined by a user-definable rule set that causes a remediation action to trigger in response to one or more conditions being observed. The external security application may then employ one or more of the remediation techniques described above, or other remediation techniques specific to the security application.

The asset store 210 stores detailed information about the network assets 150 present in the networked computer environment 100. Asset information may include, for example, an asset identifier, an asset type, a network address, cross-references to events associated with the assets, system and user information, information about installed software, history of changes to any of the above, enriched metadata from 3^{rd}-party data sources, or other information. The asset data may be indexed to a filterable and/or searchable database.

The event store 212 stores detailed information about events 160 that occur on the networked computer environment 100. Event information may comprise, for example, a timestamp (or time range) associated with an event occurrence, an event type, or various other event attributes. The event store 212 may each be associated with a time stamp and/or time range to enable detected events to be reconstructed according to the same order and relative timing at which they occurred. The event data may be indexed to a filterable and/or searchable database. In an embodiment, the asset store 210 and event store 212 may be combined in a single database.

The configuration store 214 stores various configuration data associated with the user interface. The configuration data enables the interface to be customized in various ways as will be described in the examples below.

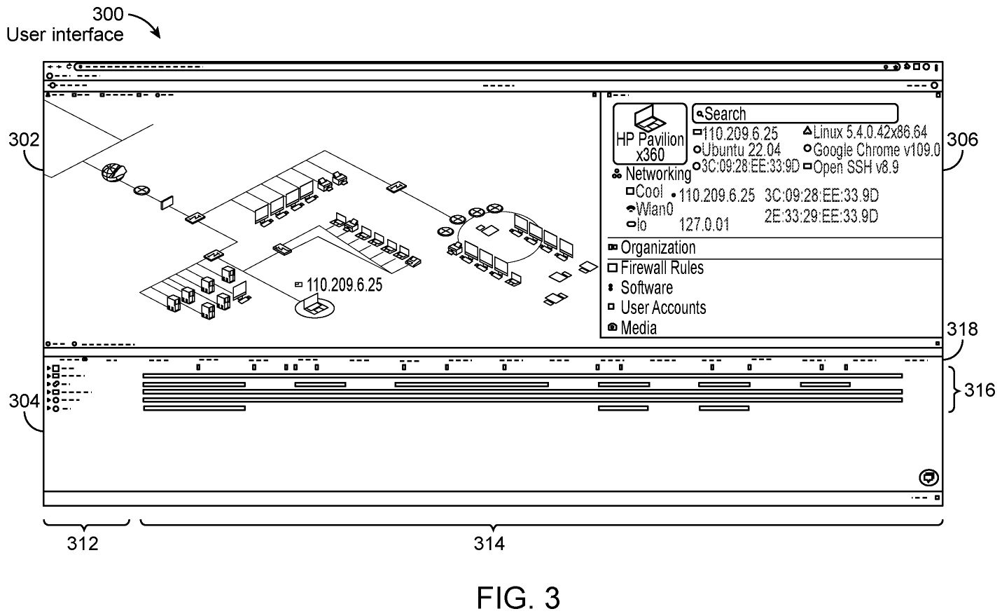

FIG. 3 illustrates an example of a user interface 300 for time-based visualization of a networked computing environment 100. In this example, the user interface 300 is divided into several panels (each comprising a sub-area of the interface) including a computer network visualization panel 302, a multi-dimensional timeline panel 304, and a details inspector panel 306. Each of the panels 302, 304, 306 provide different functionalities, may enable different types of interactions, and may display different visual information related to present and/or past states of the networked computing environment 100.

The multi-dimensional timeline panel 304 displays an interactive multi-dimensional timeline that visually represents time-based occurrences of network events 160 across multiple event categories. Each event category may define a subset of events based on one or more filters. The event categories may be specified in an event category sub-panel 312 and the events associated with each event category may be visually represented as an event lane 316 in an timeline sub-panel 314. For example, in the illustrated example, the event categories may be filtered to represent different application types associated with data event 160 such as audio/video events, chat events, network services events, web events, and events of unknown type. In an embodiment, these categories may furthermore be expandable to show event sub-categories. In other embodiments, the event categories may be based on different configurable filters. For example, event categories may filter events based on attributes such as type of event, type of device associated with the event, specific applications associated with the event, geographic locations associated with the event, business units associated with the event, etc. Custom data categories may be set based on any filterable attributes of the data events. The event categories may be exposed in a variety of views based on attributes associated with the relevant network assets 150 or events 160. For example, a default set of event categories may be based on traffic type and the relevant protocol and/or application. Other sets of event categories may be based on, for example, traffic types, destination ports, IP addresses, severity levels, domain hostnames, user personas, log type, or other asset and network identifier (e.g., vendor name or user agent string) etc.

The event lanes 316 are each indexed to a timeline 318 and include a plot of events occurrences according to their event timing. For example, the plot may include a sequence of bars or other visual indicators mapped to the timeline 318, where each bar represents an occurrence of an event 160 within the respective category. Some types of events 160 may include a start time and end time, in which case the length of the bar may be representative of the duration of the event 160. In other cases, a sequence of events 160 in close time proximity may be aggregated together into a single bar having a start time and end time indicative of the start and end of the sequence of events 160.

The different event lanes 316 may be configured to display different event occurrences according to different colors, fill patterns, shapes, annotations, effects, text, or other visual characteristics to enable a user to visually distinguish between event attributes such as event time, duration, size, severity, volume, frequency, periodicity, details, etc. Text may be provided in relation to different event occurrences to expressly describe the events and related data.

The specific visual characteristics (e.g., colors) may be automatically assigned and/or may be manually configured by the user. The visual presentation enables a user to visually see patterns of event occurrences by repetition, proximity, relatedness, density, duration, intensity, and other data dimensions. In an embodiment, multiple related events may be automatically grouped together (e.g., based on a common attribute). Here, a group icon may be indicative of the group of events and the common attribute.

The multi-dimensional timeline panel 304 may update in substantially real time as events 160 are observed. Here, the event lanes 316 may display in a scrolling window where the right edge of the display represents the current time. Thus, individual events scroll from right to left as they age. The multi-dimensional timeline panel 304 may furthermore be paused to freeze the display at a specific selected time. A replay function may enable historical events 160 to be replayed from a selected starting time. Here, the speed of the replay may be adjustable to be slower than real-time, faster than real-time, or the same as real-time.

A user may interact with the multi-dimensional timeline panel 304 in various ways. For example, a zoom-in function enables zooming into a specific period of the timeline 318 and event lanes 316 to visualize timing of events 160 during that time period in greater resolution. Similarly, a zoom-out function may zoom out to visualize the timeline 318 and associated event lanes 316 over a longer time period. A pan function enables panning through the timeline 318 and event lanes 316 to view different selected time periods at the current zoom level. The interface also enables vertical scrolling through different event categories. A repositioning function may enable the event categories and their respective event lanes 316 to be re-ordered. Furthermore, a grouping function may enable grouping or re-grouping of the different categories into category groups that may be displayed adjacent to each other in the timeline sub-panel 314. Other functions relating to the multi-dimensional timeline panel 304 are described with respect to the remaining figures.

The computer network visualization panel 302 provide a visualization of the network state at a selected time. In the illustrated example, the network state may be represented as a network topology graph including a set network assets 150 (represented as nodes) and connections between them (represented by edges) at a selected time. Different types of assets 150 may be visually distinguished using different icons (e.g., client devices, printers, firewalls, web servers, IoT devices, etc.). Furthermore, the layout in the computer network visualization panel 302 may reflect geographic locations associated with network assets 150. The computer network visualization panel 302 may furthermore depict network events 160 using various animations or other visual indicators.

In other examples, the network state may be represented using other types of visualizations such as charts, tables, maps, or other visualizations. For example, a chart or table may include text identifying the network assets 150 and a set of related fields indicating connections between the network assets 150 and/or other attributes. In another example, a map may plot locations of network assets 150 with respect to a geographic map or a floor plan together with other information such as connectivity and/or various attributes. The user interface may be configurable to enable multiple different types of visualizations to be displayed concurrently.

The computer network visualization panel 302 may update the network state in substantially real-time as events 160 are detected. The computer network visualization panel 302 may furthermore be paused to freeze the network state at a specific selected time, or may be replayed from a selected started time. The computer network visualization panel 302 may be updated synchronously with the multi-dimensional timeline panel 304 such that the computer network visualization panel 302 presents the network state associated with a corresponding selected time in the multi-dimensional timeline panel 304. The computer network visualization panel 302 may furthermore display a replayed “movie” of the network state from a selected playback time using the historical event data from the event store 212.

Various search filters may be applied to the computer network visualization panel 302 to filter the displayed results. For example, filters may be applied to limit the network assets 150 depicted in the computer network visualization panel 302 to one or more selected asset type, asset attribute, event information, or based on other filter criteria. The filters may be synchronized with interactions in the multi-dimensional timeline panel 304. For example, selecting an event category in the multi-dimensional timeline panel 304 may filter the assets 150 in the computer network visualization panel 302 consistent with the selection (e.g., by hiding assets 150 outside the selected category or visually highlighting network assets 150 in the selected category). Or for example, selecting events may display a corresponding visual playback or animated cue describing the event in the multi-dimensional timeline panel 304.

In an embodiment, multiple related assets 150 may be automatically grouped together based on one or more common attribute. For example, a cluster of virtual machines serving a similar function or sharing a common attribute may be grouped together in the computer network visualization panel 302 and displayed as a single icon representing that function or attribute.

The detailed inspector panel 306 shows detailed information pertaining to one or more selected network assets 150 or connections between assets 150 (which may be selected in the computer network visualization panel 302) or one or more events 160 (which may be selected in the multi-dimensional timeline panel 304). Types of information that may be shown about a selected network asset 150 may include, for example, a unique identifier for the asset 150, a type of asset 150, a network address, an operating system version, installed applications, etc. Types of information about events 160 may include, for example, an event time, an event type, one or more assets 150 associated with the event 160, event metadata, etc.

The detailed inspector panel 306 may comprise multiple separate panels instead of a single panel. For instance, the detailed inspector panel 306 may comprise multiple sub-panels or tabs corresponding to different types of information such as project information, asset details, event details, network packet-level information, or other information types.

The detailed inspector panel 306 may be synchronized to interactions in the computer network visualization panel 302 and/or the multi-dimensional timeline panel 304. For example, a particular asset 150 or connection may be selected in the computer network visualization panel 302 to generate an information display in the detailed inspector panel 306. Similarly, one or more events 160 may be selected in the multi-dimensional timeline panel 304 to cause the detailed inspector panel 306 to display details associated with the selected event 160. In an embodiment, a general help panel may be displayed when no asset 150 or events 160 are selected. In other instances, the detailed inspector panel 306 may display details relating to other selectable elements that do not necessarily relate directly to the network assets 150 or events 160.

The information shown in the different panels 302, 304, 306 may be synchronized in responding to network changes and/or user interactions. For example, a multi-dimensional timeline panel 304 may be linked to a computer network visualization panel 302 such that the visualization automatically updates responsive to a selection of a timepoint in the timeline 318 to show the topology at that particular timepoint. Furthermore, selecting an asset 150 in the computer network visualization panel 302 or an event 160 in the multi-dimensional timeline panel 304 may cause the inspector panel 306 to update to show details associated with the selected asset 150 or event 160.

Filtering may also be performed via interactions with element in one of the panels 302, 304, 306, which may carry through to other linked panels of different type. For example, selecting one or more assets 150 in the computer network visualization panel 302 may filter the information in the multi-dimensional timeline panel 304 to only display events 160 related to those assets 150. Additional details may likewise be displayed in the detailed inspector panel 306. Furthermore, selecting a time period in the multi-dimensional timeline panel 304 may limit the computer network visualization panel 302 to show only assets 150 that are present during the selected time period.

In an embodiment, a search function enables searching of assets 150, events 160, or other data in the user interface 300. For example, a keyword search may identify elements in multi-dimensional timeline panel 304, in the computer network visualization panel 302, and or the detailed inspector panel 306 that are relevant to the query and may provide a visual indication of the identified elements (e.g., highlighting the elements, outlining the elements, animating the elements, annotating the elements, etc.).

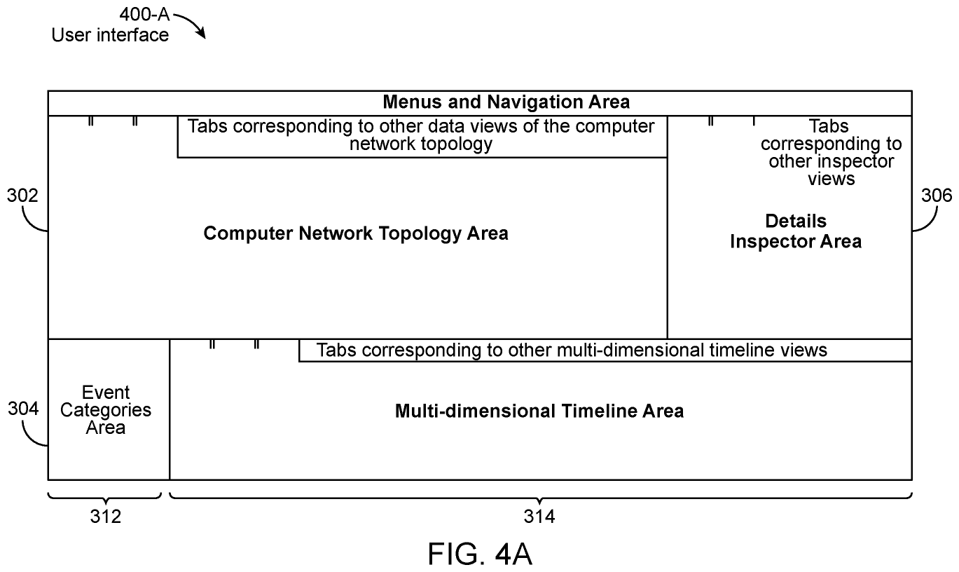

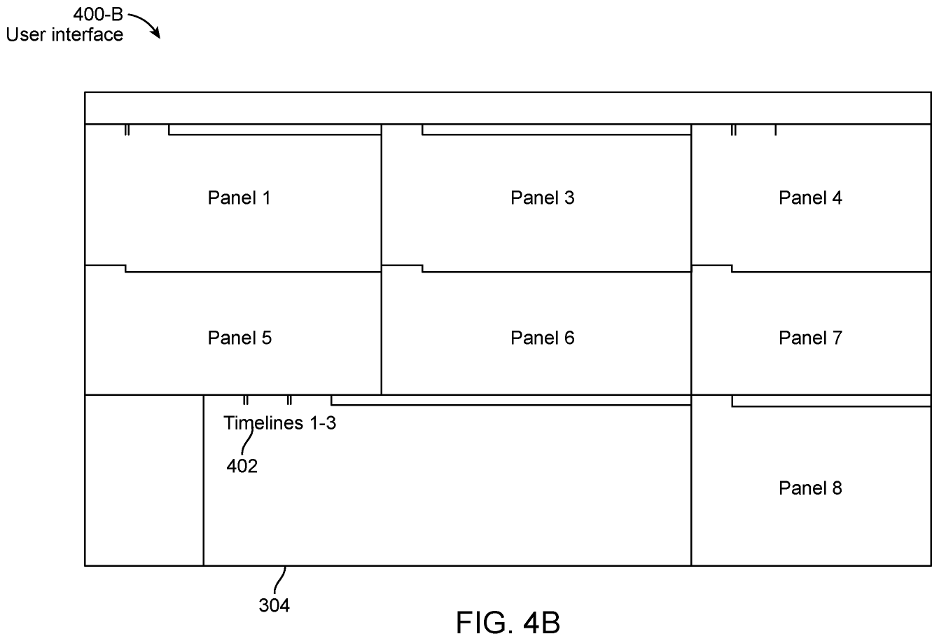

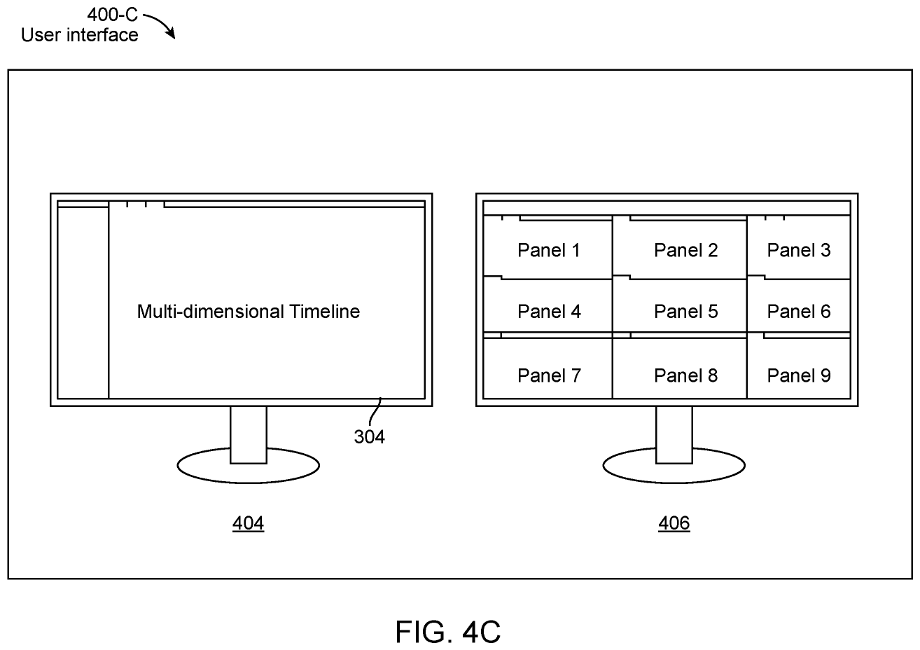

FIGS. 4A-C represent various layout configurations of a user interface 400-A, 400-B, 400-C (collectively user interface 400) for displaying time-based network security information. The interface 400 may be user-customizable to enable users to compose interfaces with different panel layout configurations including customizing the number of panels, the types of panels at each position, the sizes and positions of panels, and linkages between panels. For example, beginning with a starting layout, panels may be hidden to show fewer panels, or additional panels of a selected type may be added. Panels may furthermore be resized or repositioned in any number of positions. In an embodiment, panels may be grouped into tabs that share the same viewing area. Here, one tab of a grouping area is visible at a time, and a user may select between tabs via labeled tab selection elements (e.g., positioned at the top of each area, similar to tabs in a web browser). Panels may also be split into separate application windows and optionally maximized to enable viewing on multiple monitors or different windows of the same monitor.

A user interface 400 may also include multiple panels of the same type. Here, different panels of the same type may have different filters or other configuration settings applied to display different information. These additional instantiations allow the viewer to compare and contrast different views and states simultaneously. For example, different panels may be filtered to each show different segments of the network (e.g., relating to different locations or business groups) and/or different types of network assets 150.

FIG. 4A is a simplified view of a layout for a user interface 400-A consistent with the example in FIG. 3. This user interface 400-A may represent a default layout in which the events categories sub-panel 312 occupies a lower left portion of the interface 400-A, The timeline sub-panel 314 spans the remaining horizontal width of the lower portion of the user interface 400-A adjacent to the events categories sub-panel 312, the computer network visualization panel 302 occupies the top left portion of the interface 400-A and the detail inspector area 306 occupies the top right portion of the interface 400-A.

In FIG. 4B, a layout for a user interface 400-B includes a multi-dimensional timeline panel 304 with three different selectable tabs 402 (which may each be configured according to different filters or other configuration settings) and seven additional panels that may be selectable between different panel types. Some of the panels may also include multiple tabs.

In the example of FIG. 4C, a layout for a user interface 400-C includes a multi-dimensional timeline panel 304 that is separated into its own window maximized on a first monitor device 404, while a second window is split into nine panels and displayed on a second monitor device 406.

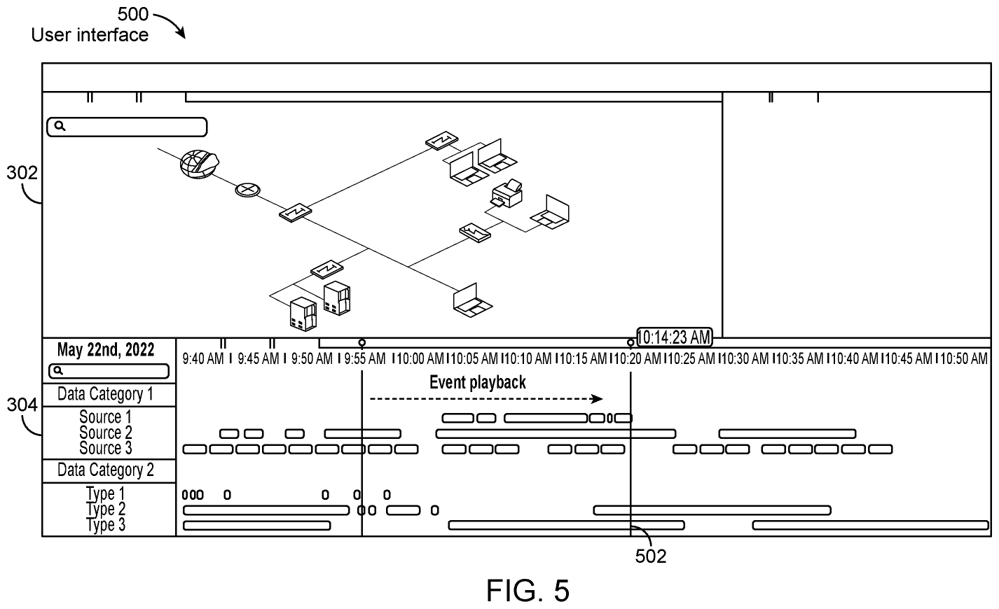

FIG. 5 illustrates another example user interface 500 showing synchronization between the multi-dimensional timeline panel 304 and the computer network visualization panel 302. Here, playback of recorded events begins from a playback time selected in the multi-dimensional timeline panel 304. Events may be played back with the current playback time shown by a timeline cursor 502. As position of the timeline cursor 502 updates, the computer network visualization panel 302 may update to reflect the synchronized network state associated with that timepoint of the timeline cursor 502.

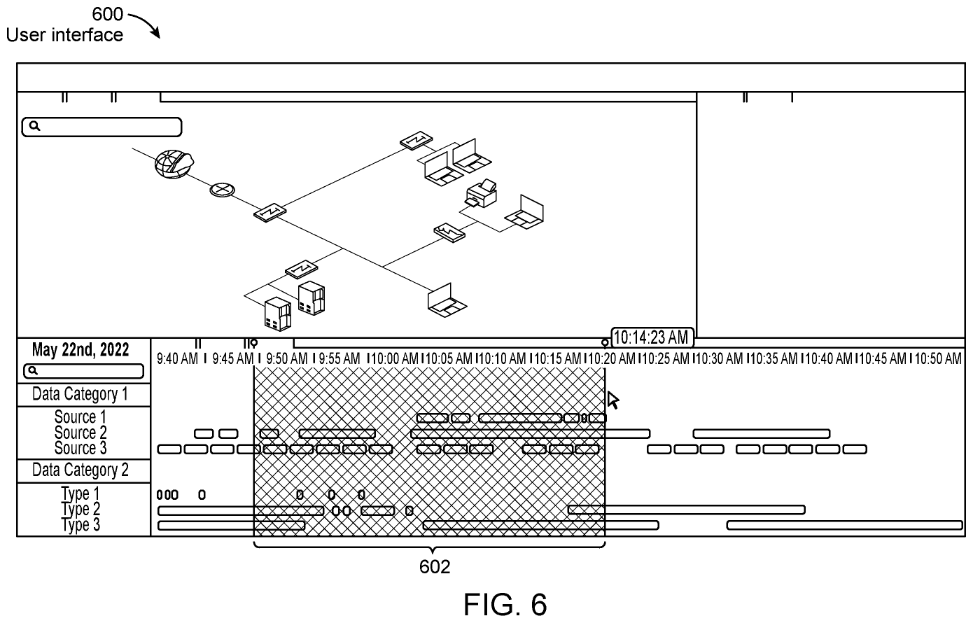

FIG. 6 illustrates an example of a comparison feature of the user interface 600. Here, a time range 602 is selected between a starting time and an ending time (e.g., using starting and ending time cursors). Upon selecting the time range 602, the computer network visualization panel 302 may be updated to show a comparison view that visually distinguishes between assets 150 and/or connections that remained the same between the start and time and end time and assets and/or connections that changed during the time period 602. In the illustrated example, assets 150 that came online or went offline during the time period may be shown in dashed lines. In other embodiments, different visual indicators may be used to distinguish between assets 150 that came online or went offline during the time period (e.g., using different line patterns, colors, animations, tags, annotations, etc.)

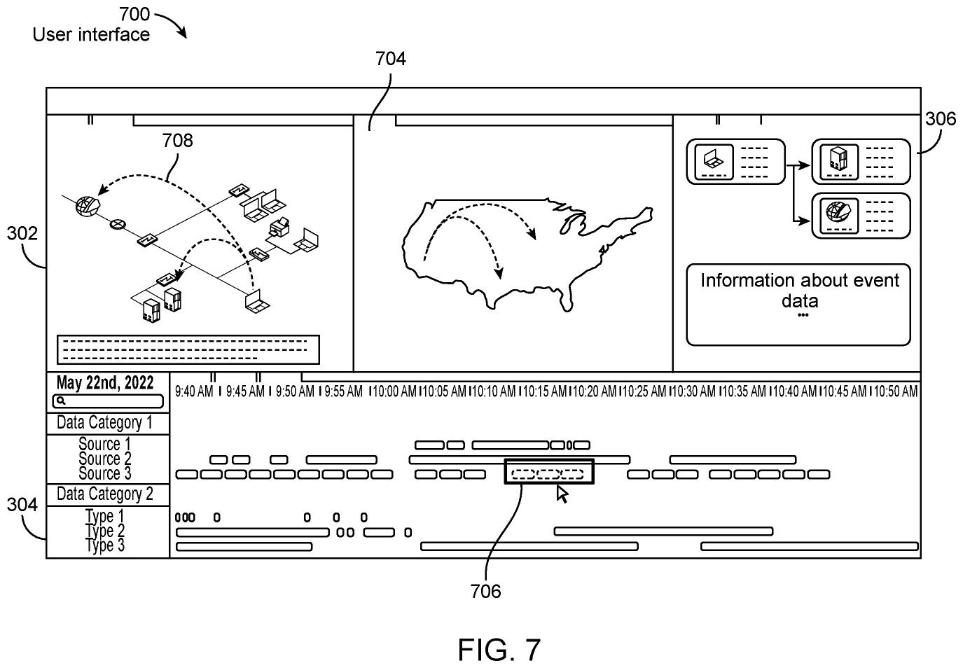

FIG. 7 illustrates an example of a selection feature in the user interface 700. Here, a set of data events 706 are selected in the multi-dimensional timeline panel 304. In response to the selection, visual indicators 708 are displayed in the computer network visualization panel 302 to indicate the assets 150 associated with the events. The indicators 708 may furthermore show a direction of communications associated with the selected data events. FIG. 7 also illustrates a map view 704 that a shows a visualization of the selected data events 706 plotted against the geographic locations of the network assets 150 associated with the events 706. As described above, the user interface 700 may additionally or alternatively include other types of visualizations of the network state such as charts. The detailed inspector panel 306 may show additional detailed information relating to the selected data events 706, the assets involved, and their various attributes.

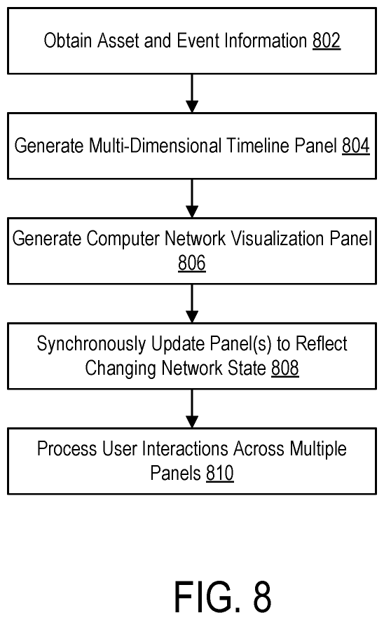

FIG. 8 illustrates an example embodiment of a process for generating and operating a user interface that produces time-based visualizations of network assets, events, and their attributes. The security server 110 obtains 802 asset and event information associated with a networked computer environment. The security server 110 processes the asset and event information to generate 804 a multi-dimensional timeline panel 304 that includes multiple event lanes (e.g., each in independent rows aligned according to a timeline) corresponding to different event categories and plots occurrences of events in the respective categories according to their timing. The event lanes may depict the events using different colors, animations, shapes, or other visual attributes to distinguish between different event attributes such as event time, duration, size, severity, etc. The security server 110 furthermore generates 806 a computer network visualization panel 302 that visually depicts a network state comprising visual assets and connections between them. The multi-dimensional timeline panel 304 and computer network visualization panel 302 may synchronously update 808 over time to reflect changes to the network state. Changes may reflect the real-time network state or playback of changing network state based on historical events. Furthermore, the security server 110 may process 810 interactions with the user interface to synchronously update display across multiple panels in response to the interactions. For example, the multi-dimensional timeline panel 304 may depict a selected time window range with a current playback time indicated by a playhead indicator. Selection of a timepoint in the multi-dimensional timeline panel 304 causes the computer network visualization panel 302 to be updated to reflect the network state at the selected time point. Furthermore, a playback time may be selected in the multi-dimensional timeline panel 304 to cause the computer network visualization panel 302 to playback the sequence of network states at each of a sequence of timepoint during the playback period. For playback of historical events, the playback speed may be user-configurable. Furthermore, the multi-dimensional timeline may enable selection of a time range and/or individual event occurrences to cause display of additional information relevant to selected events (or all events within the time range). Additional information may be displayed in a separate detailed inspector panel 306 that updates in correspondence with selected elements in the computer network visualization panel 302 or events in the multi-dimensional timeline panel 304.

In an embodiment, the user interface is composable to enable user-customized selection of panels of different panel types, size of panels, position of panels, tab configurations, or other customizations. Additional panels may similarly update synchronously in response to changes in the network state, events, or user interactions with a different panel. The multi-dimensional timeline panel 304 may be zoomable, pan-able, and scrollable to enable viewing of different time periods and/or event categories. In an embodiment, assets or events may furthermore be searchable and/or filtered based on respective attributes.

The described security server 110 provides user interfaces that enable users to quickly investigate and visualize specific events of a computer network in one or more view perspectives. The composability of the interface panels enables users with complex analysis workflows to efficiently pivot between additional assets, events, and data dimensions of a computer network without becoming limited by any default arrangement. Representing a network using a time-based visualization in this manner allows users to view multiple assets, events and data dimensions, without losing orientation, maximizing situational awareness of everything together. Users may scrub through the multi-dimensional to view changes to the time-based computer network visualization. Users may range select portions of the timeline to see delta changes, to the computer network environment within certain time periods. An administrator may efficiently identify patterns associated with malicious activity and initiate remediation actions in response to improve network security.

The foregoing description of the embodiments has been presented for the purpose of illustration; it is not intended to be exhaustive or to limit the embodiments to the precise forms disclosed. Persons skilled in the relevant art can appreciate that many modifications and variations are possible in light of the above disclosure.

Some portions of this description describe the embodiments in terms of algorithms and symbolic representations of operations on information. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. Embodiments may also relate to an apparatus for performing the operations herein. This apparatus may be specially constructed for the required purposes, and/or it may include a general-purpose computing device selectively activated or reconfigured by a computer program stored in the computer. Such a computer program may be stored in a tangible non-transitory computer readable storage medium or any type of media suitable for storing electronic instructions and coupled to a computer system bus. Furthermore, any computing systems referred to in the specification may include a single processor or may be architectures employing multiple processor designs for increased computing capability.

Finally, the language used in the specification has been principally selected for readability and instructional purposes, and it may not have been selected to delineate or circumscribe the inventive subject matter. It is therefore intended that the scope is not limited by this detailed description, but rather by any claims that issue on an application based hereon. Accordingly, the disclosure of the embodiments is intended to be illustrative, but not limiting, of the scope of the invention, which is set forth in the following claims.

1. A method for identifying network security risks in a networked computing environments, the method comprising:
obtaining at a security server at each of a sequence of timepoints, asset information associated with a set of observed assets in the networked computing environment at each of the sequence of timepoints, and event information associated with observed occurrences of events associated with operation of the set of assets in the networked computing environment at each of the sequence of timepoints;
generating a multi-dimensional timeline panel of a user interface that includes at least one event lane associated with an event category, wherein the event lane comprises a graphical plot of timing, relative to a timeline, of the observed occurrences of the events that fall within the event category, and wherein the multi-dimensional timeline panel indicates one or more active timepoints on the timeline;
generating a computer network visualization panel of the user interface depicting a graphical view of a network state associated with the one or more active timepoints, the graphical view of the network state including a visual representation of at least a subset of the observed assets and connections between the subset of the observed assets associated with the one or more active timepoints;
synchronously updating display of the computer network visualization panel and the multi-dimensional timeline panel to reflect changes in the one or more active timepoints and corresponding changes in the network state associated with the one or more active timepoints;
receiving, via a user input device, one or more interactions with the user interface; and
synchronously updating the multi-dimensional timeline panel and the computer network visualization panel responsive to the one or more interactions.

2. The method of claim 1, wherein the at least one event lane includes at least two event lanes associated with different event categories.

3. The method of claim 1, wherein the at least one event lane depicts the observed occurrences of the events using visually distinguishable features corresponding to different attributes of the events defined in the event information.

4. The method of claim 3, wherein the visually distinguishable features comprise at least one of: color, shape, size, text, and animation type.

5. The method of claim 3, wherein the different attributes of the events comprise at least one of: an event time, an event duration, an event size, event severity, and an event type.

6. The method of claim 1, wherein the one or more active timepoints comprises a current timepoint that updates in substantially real-time to reflect a current real-time timepoint.

7. The method of claim 1, wherein the one or more active timepoints comprises a historical timepoint that updates incrementally according to a playback speed to reflect a playback of changing network state from a historical playback point.

8. The method of claim 1, wherein the one or more active timepoints comprises at least a first selected timepoint and a second selected timepoint, and wherein the graphical view of the network state represents a differential between a first network state associated with the first selected timepoint and a second network state associated with the second selected timepoint.

9. The method of claim 1, further comprising:
generating a detailed inspector panel of the user interface that displays at least a subset of the asset information or the event information for one or more selected assets or one or more selected events.

10. The method of claim 1, wherein the user interface comprises a set of user-composable panels or tabs that are configurable with respect to one or more of: position, size, number, and type.

11. The method of claim 10, wherein the user-composable panels or tabs include at least two panels or tabs of a same type that are configurable with different filtering criteria.

12. The method of claim 10, wherein the user-composable panels or tabs all update synchronously responsive to the changes in the one or more active timepoints and to the one or more interactions.

13. The method of claim 1, wherein receiving the one or more interactions and synchronously updating the multi-dimensional timeline panel and the computer network visualization panel comprises:
receiving a selection of a playback time on the timeline of the multi-dimensional timeline panel; and
updating the network state in the computer network visualization panel responsive to the selection.

14. The method of claim 1, wherein receiving the one or more interactions and synchronously updating the multi-dimensional timeline panel and the computer network visualization panel comprises:
receiving a selection of a user interface element representing an asset in the computer network visualization panel; and
updating the multi-dimensional timeline panel to indicate one or more timepoints of events associated with the asset.

15. The method of claim 1, wherein receiving the one or more interactions and synchronously updating the multi-dimensional timeline panel and the computer network visualization panel comprises:
receiving a selection of an event lane associated with an event category in the multi-dimensional timeline panel; and
updating the computer network visualization panel to visually identify assets associated with event occurrences in the event category.

16. The method of claim 1, wherein receiving the one or more interactions and synchronously updating the multi-dimensional timeline panel and the computer network visualization panel comprises:
receiving search or filter query associated with one or more attributes; and
updating the computer network visualization panel and the multi-dimensional timeline panel to visually identify assets and events meeting the search or filter query.

17. The method of claim 1, wherein receiving the one or more interactions and synchronously updating the multi-dimensional timeline panel and the computer network visualization panel comprises:
receiving a selection of a set of events in the multi-dimensional timeline panel; and
displaying a visualization in the computer network visualization panel indicating assets associated with the set of events.

18. The method of claim 1, wherein the event category is indicative of at least one of: a type of event, a type of device associated with the event, a type of application associated with the event, user associated with event, one or more network identifiers, and one or more asset identifiers.

19. A non-transitory computer-readable storage medium storing instructions for identifying network security risks in a networked computing environments, the instructions when executed by a processor cause the processor to perform steps including:
obtaining at a security server at each of a sequence of timepoints, asset information associated with a set of observed assets in the networked computing environment at each of the sequence of timepoints, and event information associated with observed occurrences of events associated with operation of the set of assets in the networked computing environment at each of the sequence of timepoints;
generating a multi-dimensional timeline panel of a user interface that includes at least one event lane associated with an event category, wherein the event lane comprises a graphical plot of timing, relative to a timeline, of the observed occurrences of the events that fall within the event category, and wherein the multi-dimensional timeline panel indicates one or more active timepoints on the timeline;
generating a computer network visualization panel of the user interface depicting a graphical view of a network state associated with the one or more active timepoints, the graphical view of the network state including a visualization of at least a subset of the observed assets and connections between the subset of the observed assets associated with the one or more active timepoints;
synchronously updating display of the computer network visualization panel and the multi-dimensional timeline panel to reflect changes in the one or more active timepoints and corresponding changes in the network state associated with the one or more active timepoints;
receiving, via a user input device, one or more interactions with the user interface; and
synchronously updating the multi-dimensional timeline panel and the computer network visualization panel responsive to the one or more interactions.

20. A computer system comprising:
one or more processors; and
a non-transitory computer-readable storage medium storing instructions for identifying network security risks in a networked computing environments, the instructions when executed by the one or more processors cause the one or more processors to perform steps including:
obtaining at a security server at each of a sequence of timepoints, asset information associated with a set of observed assets in the networked computing environment at each of the sequence of timepoints, and event information associated with observed occurrences of events associated with operation of the set of assets in the networked computing environment at each of the sequence of timepoints;
generating a multi-dimensional timeline panel of a user interface that includes at least one event lane associated with an event category, wherein the event lane comprises a graphical plot of timing, relative to a timeline, of the observed occurrences of the events that fall within the event category, and wherein the multi-dimensional timeline panel indicates one or more active timepoints on the timeline;
generating a computer network visualization panel of the user interface depicting a graphical view of a network state associated with the one or more active timepoints, the graphical view of the network state including a visualization of at least a subset of the observed assets and connections between the subset of the observed assets associated with the one or more active timepoints;
synchronously updating display of the computer network visualization panel and the multi-dimensional timeline panel to reflect changes in the one or more active timepoints and corresponding changes in the network state associated with the one or more active timepoints;
receiving, via a user input device, one or more interactions with the user interface; and
synchronously updating the multi-dimensional timeline panel and the computer network visualization panel responsive to the one or more interactions.
